(19) United States
(12) Patent Application Publication
(10) Pub. No.: US 2014/0229381 A1
(43) Pub. Date: Aug. 14, 2014

(54) FINANCIAL TRANSACTION RELAY SYSTEM USING MOBILE TERMINAL

(71) Applicant: UBGreen CO., LTD., Seoul (KR)

(72) Inventor: Wang-Ju Lee, Seoul (KR)

(73) Assignee: UBGreen CO., LTD., Seoul (KR)

(21) Appl. No.: 14/129,752

(22) PCT Filed: Oct. 24, 2012
(86) PCT No.: PCT/KR2012/008773

§ 371 Date: Dec. 27, 2013

(30) Foreign Application Priority Data
Nov. 1, 2011 (KR) 10-2011-0112896

(51) Int. Cl. G06Q 20/32

(52) U.S. Cl. CPC G06Q 20/3223
USPC 705/44

(57) ABSTRACT

Disclosed is a financial transaction relay system using a mobile terminal, capable of allowing a user of a mobile terminal to perform payment or receive payment using the mobile terminal, even if the user does not know a payment means or a payment place of another party. The financial transaction relay system is configured to perform a financial transaction with respect to a product cost, a service cost and to perform a general money transfer.

### TECHNICAL FIELD

The present invention relates to a financial transaction relay system using a mobile terminal, and more particularly, to a financial transaction relay system using a mobile terminal capable of relaying a financial transaction between mobile terminals, capable of enhancing security of a mobile financial transaction by using online ID card information rather than using a credit card and an account number, and capable of relaying purchase of a product and a service using the same.

### BACKGROUND ART

In recent years, a portable phone or a smart phone is provided with a chip for payment therein, and serves to perform micropayment of a mobile environment using the mounted chip.

Mobile payment is advantageous in that a smart phone (or a portable phone) user can purchase a product without money. However, such mobile payment is disadvantageous in that a user cannot pay in a state where a dedicated chip is not mounted in a smart phone (or a portable phone), and the payment amount is limited. Especially, a direct financial transaction is not performed between portable phone users. This may result from that micro payment of a mobile environment can be performed only in a store equipped with a reader for recognizing a chip mounted in a smart phone (or a portable phone). The current mobile payment is not implemented through direct account transfer of portable terminal users, or through pay for a product or a service.

Further, it is difficult to obtain security when financial information is transmitted and received (transceived), because a mobile phone (or a smart phone) uses wireless communication. A WiFi zone and a public wireless network having weak security prevent a mobile financial transaction from spreading.

Accordingly, the present applicant provides a mobile payment environment between smart phone users. Further, the present applicant proposes a financial transaction relay system using a mobile terminal capable of allowing a user to directly perform payment for a product cost and a service cost, and capable of enhancing security in a mobile financial transaction environment.

### DISCLOSURE OF THE INVENTION

Therefore, an object of the present invention is to provide a financial transaction relay system using a mobile terminal, capable of allowing a user of a terminal to pay for a product and a service or to receive payment.

To achieve these and other advantages and in accordance with the purpose of the present invention, as embodied and broadly described herein, there is provided a financial transaction relay system using a mobile terminal, comprising: an online ID (OID) registration module configured to acquire a region of an online ID corresponding to one of card information and account information, from a financial institution server; a payment relay module configured to receive, from a first mobile terminal which purchases a good and a service, address information of a second mobile terminal which provides the product and the service, a payment cost, and member store information on the first mobile terminal, and configured to provide the member store information to a financial institution server to thus request payment; an OID relay module configured to provide mapping information on a payment means of the first mobile terminal, by providing a region of an OID with respect to the first mobile terminal, to the financial institution server; an OTP relay module configured to acquire an One Time Password (OTP) for the payment from the financial institution server, configured to provide the acquired OTP to the first mobile terminal, configured to receive a response, and configured to provide the response to the financial institution server to thus authenticate the first mobile terminal, wherein the financial institution server determines the payment means using an entire OID with respect to one region of the OID.

When the financial transaction relay system using a mobile terminal according to the present invention is applied to a product transaction, the product transaction may be performed using a QR barcode formed in an offline medium or an online medium.

When the financial transaction relay system using a mobile terminal according to the present invention is applied to a service transaction, a designated driving requester and a designated driver applicant may be connected to each other using mobile terminals, and payment for a designated driving may be performed by the mobile terminals.

The financial transaction relay system using a mobile terminal according to the present invention can have the following advantages.

Firstly, payment for a product or a service can be performed using a mobile terminal in a mobile environment. Further, payment in a mobile environment can be executed with a minimized change of a financial institution server.

### BRIEF DESCRIPTION OF THE DRAWINGS

FIG. 1 is a conceptual view of a financial transaction relay system using a mobile terminal according to an embodiment of the present invention;

FIG. 2 is a conceptual view of a financial transaction relay system using a mobile terminal according to another embodiment of the present invention;

FIG. 3 is a conceptual view of a financial transaction relay system using a mobile terminal according to another embodiment of the present invention;

FIG. 4 is a conceptual view of a financial transaction relay system using a mobile terminal according to another embodiment of the present invention;

FIG. 5 is a block diagram of a financial transaction relay system using a mobile terminal according to an embodiment of the present invention;

FIGS. 6 to 8 are views for explaining payment procedures using a mobile terminal;

FIG. 9 is a conceptual view of a financial transaction relay system using a mobile terminal according to another embodiment of the present invention; and

FIG. 10 is a view for explaining payment request procedures using a mobile terminal.

### MODES FOR CARRYING OUT THE PREFERRED EMBODIMENTS

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail of a drain device and a refrigerator having the same according to an embodiment, with reference to the accompanying drawings.

A financial institution server of the present invention may include a card company server, a bank server, a Payment Gateway (PG) server, and various types of financial agency servers. Alternatively, the financial institution server may be implemented as a card company server includes a Payment Gateway (PG) server or a Value Added Network (VAN) server.

Online ID card information of the present invention may be issued to a mobile terminal from a financial institution, especially, a bank. The online ID card information may be utilized instead of a bank account or a credit card of a user of the mobile terminal. The online ID card information needs not include card information, account information and personal information.

The online ID card information may be used to allow a financial institution such as a PG company which performs a financial transaction, rather than a bank or a card company, to relay payment or account transfer in a mobile environment. The online ID card information may be implemented in the form of keys where numbers, characters and special characters are selectively combined to one another. Some of the online ID card information may be provided to a mobile terminal, and others thereof may be provided to a relay system of the present invention. Accordingly, even if some of the online ID card information provided to the relay system from a mobile terminal is exposed to outside, another person cannot easily utilize the information.

The online ID card information may be implemented in the form of a file or a unique key, for utilization in a mobile terminal. The online ID card information is preferably implemented as a unique key, because it is utilized in a financial transaction.

An one time password (OTP) of the present invention may be used for a user's authentication, or may be used as payment basic information. If the OTP is used only for a user's authentication, the OTP is preferably automatically abandoned upon completion of a user's authentication. On the other hand, if the OTP is used as payment basic information, a generated OTP may be provided to a financial institution server.

Costs of the present invention mean product sales costs and service sales costs. However, the costs may include account transfer between two users. That is, it may be expressed that costs have been provided even in a case where a product or a service is not provided.

A mobile terminal of the present invention may be connected to a relay system, and may request or allow payment. The mobile terminal means a portable phone, a smart phone, a Personal Digital Assistant (PDA), a notebook, and other type of mobile terminal which can be carried by a user. Any device, which can request or allow payment by accessing a relay system, is regarded as a mobile terminal. Therefore, the mobile terminal may be implemented in various forms.

In the present invention, reference numeral 60 denotes a mobile terminal which requests a product or a service, and reference numeral 50 denotes a mobile terminal which provides a product or a service.

The term of ‘payment request’ of the present invention means request payment for a product or a service. The payment request may be applicable to account transfer between users to whom a product or a service is not provided, and a financial transaction. The term of ‘payment approval’ means that a cost receiving side allows cost reception with respect to a payment request.

In a case where the mobile terminal of the preset invention requests payment for costs and performs payment approval, costing processes are executed by an application (App) installed at the mobile terminal. The mobile terminal is connected to a relay system as the application is driven. Under the connected state, the mobile terminal may perform a payment request and a payment approval. For convenience, it is assumed that explanations where the mobile terminal is the subject indicate explanations where an application installed at the mobile terminal performs processes.

Considering the recent trend that a PG server and a VAN server are integrated with a card company server, a financial institution server of the present invention may be a card company server and a bank server each including functions of such PG server or VAN server. Accordingly, functions of the PG server or the VAN server may be also explained when a financial institution server is explained. The financial institution server of the present invention may be implemented as a PG server, a card company server and a bank server independent from one another.

Hereinafter, the present invention will be explained in more detail with reference to the attached drawings.

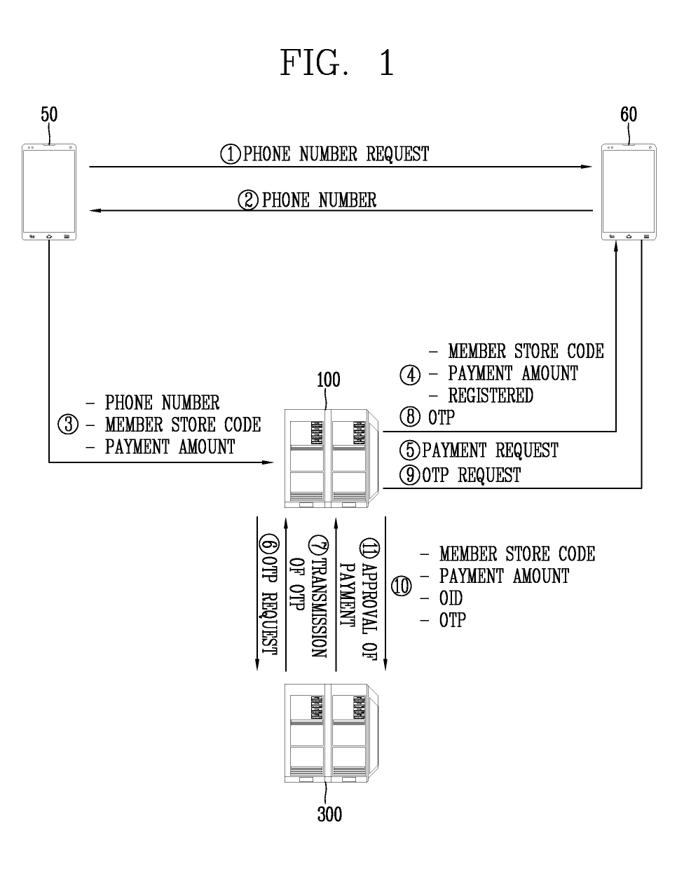

FIG. 1 is a conceptual view of a financial transaction relay system using a mobile terminal according to an embodiment of the present invention.

Referring to FIG. 1, the financial transaction relay system using a mobile terminal (hereinafter, will be referred to as ‘relay system’ 100) according to the present invention is configured to relay payment between a mobile terminal 60 for purchasing a product or a service, and a mobile terminal 50 for selling a product or a service.

When the mobile terminals 50 and 60 perform a reciprocal payment, the relay system 100 should submit a region of an Online ID (OID) obtained from a financial institution server 300, to the financial institution server 300.

The relay system 100 is provided with only one region of an OID, not the entire region of the OID. Once the relay system 100 submits a region of an OID to the financial institution server 300, the financial institution server 300 determines the entire OID which matches said one region of an OID. Then, the financial institution server 300 may determine a credit card or an account number corresponding to the determined OID. That is, the financial institution server 300 can check users of the mobile terminals 50 and 60, while credit card information or account information of the users is not exposed by the OID.

The OID is unique information which replaces a user's credit card and account number, which may be implemented in the form of keys where numbers, characters and special characters are selectively combined to one another. For security, the OID is issued from the financial institution server 300 (e.g., a card company), and is partially provided to the relay system 100.

In a case where one mobile terminal 60 of the two mobile terminals 50 and 60 requests payment, if the mobile terminal 60 selects a card company and a card type of the card company, the relay system 100 may request the financial institution server 300 to perform payment procedures using a region of an OID of the card of the card company.

Generally, data of the mobile terminals 50 and 60 is transmitted to the relay system 100 through a wireless network. In this case, security is weaker than in a case where data is transmitted through a wired network. Even if OID is exposed to outside, risk due to the exposure is very small because the OID does not include card information, account information and personal information. Further, the OID is merely a code corresponding to a card company and a card name, and is not provided to the relay system 100 from the mobile terminals 50 and 60. Further, as part of an OID is provided to the financial institution server 300 from the relay server 100, even an entire key value of the OID is not exposed to outside.

The entire key value of the OID may be frequently changed for security of the relay system 100 and the financial institution server 300. Accordingly, a financial accident does not occur even if the relay system 100 is hacked. Further, account information or card information corresponding to OID cannot be exposed to outside by a hacker or another party, because it exists at the financial institution server 300 such as a bank server and a card company server.

An OID may be configured as number strings, character strings, special character strings, numbers and characters are combined with one another, or as numbers and characters are combined with one another. Alternatively, the OID may be configured as characters and specific characters are combined with one another, or as characters, numbers and specific characters are selectively combined with one another. For enhanced security, the OID is preferably configured to have more than 4 digitals. The length of a key value of the OID may be much increased according to a contract between the relay system 100 and the financial institution server 300.

The relay system 100 may receive part of an OID from the financial institution server 300, and may receive an OTP from the financial institution server 300 when the mobile terminal 60 requests the mobile terminal 50 to pay. Then, the relay system 100 provides the OTP to the mobile terminal 60, and then may authenticate the mobile terminal 60 by being fed back with the OTP. The financial institution server 300 may authenticate the mobile terminal 60 using the OTP, and may provide, to the mobile terminal 60, an interface or interface information by which the relay system 100 selects a credit card or an account. A user of the mobile terminal 60 may inform the relay system 100 of a credit card or an account number to be used for payment. Then, the financial institution server 300 may perform card payment or account transfer between the mobile terminals 50 and 60, using an OID provided from the relay system 100 and a payment means selected by a user.

In case of performing a product transaction, a service transaction and a account transfer, the relay system 100 does not require card information, account information, or validity information on such card information and account information. Whether such card information and account information is valid or not may be determined by the financial institution server 300 having card information or account information corresponding to an OID. Whether to perform a product transaction, a service transaction and a account transfer may be determined according to a result of the determination.

Once the mobile terminal 60 requests the relay system 100 to pay, the mobile terminal 60 which requests a product or a service may receive an OTP transmitted from the relay system 100 through the financial institution server 300 for dealer authentication.

The OTP, which is used to authenticate the mobile terminal 60 related to payment, may be arbitrarily generated from the financial institution server 300 to thus be provided to the relay system 100. Then, the OTP may be provided to the mobile terminal 60 through a communication company server 250. The mobile terminal 60 informs the OTP provided from the financial institution server 300 to the mobile terminal 60, and provides the OTP received by the mobile terminal 60 to the relay system 100. As a result, the mobile terminal 60 related to payment can be authenticated.

The OTP may be used to authenticate the mobile terminal 60, or may be used as payment basic information for payment. In this embodiment, the OTP is used to authenticate the mobile terminal 60. An embodiment, where the OTP is used as payment basic information for payment, will be explained later in more detail. If the OTP is used only for authentication of the mobile terminal 50 or 60, the relay system 100 preferably abandons the generated OTP after authentication of the mobile terminal 50 or 60 is completed. In this case, the financial institution server 300 may provide an additional approval number to the relay system 100 using a short message service (SMS), the relay system 100 may transmit the approval number to the mobile terminal 60, and the relay system 100 may feedback the approval number received by the mobile terminal 60 to the financial institution server 300. In this manner, the financial institution server 300 may additionally perform a process for authenticating the mobile terminal 60. However, in this embodiment, the authentication process performed by the financial institution server 300 using the OTP may be omitted, because it corresponds to a repeated authentication.

In case of performing payment between the mobile terminals 50 and 60, the mobile terminal 50 which provides one of a product and a service may provide or not provide a card member store code to the relay system 100. In a case where a user of the mobile terminal 50 is registered in a card member store, the mobile terminal 50 should provide a member store code to the relay system 100 when approving payment. A user of the mobile terminal 50 may serve to provide a product or a service, and the financial institution server 300 may be a card company server in a case where a user of the mobile terminal 60 wishes to perform card payment with respect to “payment request”. Therefore, the mobile terminal 50 should provide requested costs and a member store code to the relay system 100, when approval of the mobile terminal 60 is performed with respect to the “payment request”. The relay system 100 should provide the requested costs and the member store code to the financial institution server 300, in order to request “payment approval”.

In a case where a user of the mobile terminal 50 which provides a product or a service is not registered in a card member store, it may be difficult to pay using a credit card. In this case, the relay system 100 may provide a member store code to the financial institution server 300 instead of the mobile terminal 50. That is, if a user of the mobile terminal 60 which provides a product or a service is not registered in a card member store, the relay system 100 may perform payment procedures using a member store code thereof, instead of a member store. Then, the relay system 100 may receive payment costs paid through an account or a card of the user of the mobile terminal 50.

It is assumed that reference numeral 60 denotes a mobile terminal which performs payment, and reference numeral 50 denotes a mobile terminal which provides a product and a service. However, reference numeral 50 denotes a mobile terminal which performs payment, and reference numeral 60 denotes a mobile terminal which provides a product and a service. In this case, a member store code may be provided to the relay system 100 from the mobile terminal 50.

Processes for the relay system 100 to provide a member store code to the member store institution server 300 instead of a card member store are equally applied to the following embodiments.

An application (App), a program having the following functions, may be driven by the mobile terminals 50 and 60.

-Below-

A function to wirelessly connect to the relay system 100

A function to display an interface for payment on a screen of the mobile terminal 60. The interface may include a menu for depositing payment costs, and a menu for transmitting a request for a payment result on a payment amount, to the relay system 100.

The interface may include an interface for requesting and receiving a result on payment.

The interface may include an interface for writing an OTP and transmitting the OTP to the relay system 100.

The mobile terminal 50 may be provided with an accredited certificate mounted therein, and may be used to pay for requested costs using the accredited certificate.

In a case where the mobile terminal 60 wishes to perform payment for a product cost or a service cost to the mobile terminal 50, the mobile terminal 50 may request a phone number to the mobile terminal 60, and provide the obtained phone number, a payment amount, and member store information (member store code, member store name, etc.) to the relay system 100.

Then, the relay system 100 provides the mobile terminal 60 with member store information, a payment amount, and card information registered in the relay system 100. In this case, the mobile terminal 60 displays the card information so that a user of the mobile terminal 60 can select a card for payment. An application installed at the mobile terminal 60 displays card information, and card information selected by a user is transmitted to the relay system 100.

Once the mobile terminal 60 checks a payment amount provided from the relay system 100 and requests payment, the relay system 100 informs the request to the financial institution server 300. The relay system 100 may provide a region of an OID obtained from the financial institution server 300.

The financial institution server 300 may form a complete OID with reference to a region of the OID provided from the relay system 100, and may search card information or account information mapping with the complete OID. And the financial institution server 300 may perform payment based on the mapped card information or account information.

Once the relay system 100 provides a payment request of the mobile terminal 60 to the financial institution server 300, the financial institution server 300 may generate an OTP. Then, the financial institution server 300 may provide the OTP to the mobile terminal 60 through the relay system 100, thereby performing an authentication process for final approval.

The mobile terminal 60 serves to perform payment, and the mobile terminal 50 serves to receive payment. The mobile terminal 60 may be a personal computer 55, a notebook, or a portable terminal where network communication is enabled. For check of a user and an OTP, a mobile terminal which purchases a product or a service, i.e., a subject which requests payment is preferably a portable type of terminal (i.e., the mobile terminal 60) such as a portable phone or a smart phone. When the mobile terminal 60 requests the relay system 100 to pay, a payment application is preferably driven in the mobile terminal 60.

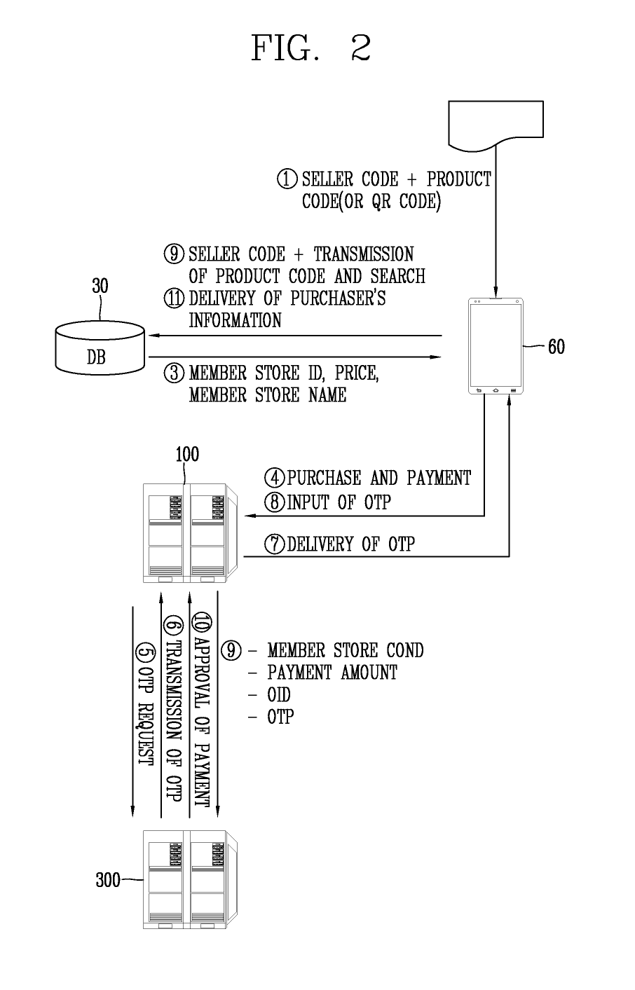

FIG. 2 is a conceptual view of a financial transaction relay system using a mobile terminal according to another embodiment of the present invention.

FIG. 2 illustrates that the relay system serves to relay a product transaction. Referring to FIG. 2, the mobile terminal 60 may capture a barcode (e.g., QR (Quick Response) code) written on an offline medium such as an advertising paper, an advertising board, a newspaper or a magazine, using a camera (not shown) mounted therein, and may provide the captured barcode to the relay system 100. Alternatively, the mobile terminal 60 may read a QR code and then provide the read QR code. In a case where a barcode is configured as a number strings, the mobile terminal 60 may directly type the barcode to thus provide it to the relay system 100. A method for providing a barcode to the relay system 100 may be performed in the following manner.

-Below-

If a product code is a barcode (QR code), the mobile terminal 60 may access a product service server 30 having member store information such as a member store ID and a member store name corresponding to the product code, to thus obtain member store information corresponding to the product code. Then, the mobile terminal 60 may transmit the obtained member store information to the relay system 100, in order to request payment. In this case, an application (App) should be provided with an access path with respect to the product service server 30. The mobile terminal 60 may request member store information by transmitting a barcode or a QR code captured by a user thereof using a camera thereof, to the product service server 30. For delivery of a product, the App may provide purchase information such as a purchase name, an address and a phone number, to the product service server 30.

In a case where a product code is a barcode or a QR code, the mobile terminal 60 may capture the product code to provide it to the relay system 100.

In a case where a product code is a barcode or a QR code, the mobile terminal 60 may capture the product code to read a barcode. Then, the mobile terminal 60 may provide the read barcode to the relay system 100. In this case, an App should have a function for reading a barcode or a QR code.

In a case where a product code is implemented in the form of number strings or numbers and characters combined with each other, a user of the mobile terminal 50 may type the product code using an interface of an App, and may provide the typed product code to the relay system 100.

Under an assumption that reference numeral 60 denotes a purchaser's mobile terminal and reference numeral 50 denotes a product seller's mobile terminal, the relay system 100 may acquire information on the seller and a store, and may request the store to delivery an ordered product. The purchaser may receive the ordered product, and then may inform the relay system 100 of the product reception. The relay system 100 may request an OTP from the financial institution server 300, and provide the received OTP to the mobile terminal 60. Accordingly, the relay system 100 may perform payment upon authentication of the mobile terminal 60, in the same manner as the aforementioned method in FIG. 1.

The relay system 100 may provide a region of an OID to the financial institution server 300, thereby requesting payment. The OID provided to the financial institution server 300 from the relay system 100 does not include card information or account information. Card information or account information mapping with the OID is selected by the financial institution server 300. The financial institution server 300 may process payment requested by a user of the mobile terminal 60, based on the mapped card information or account information. Then, the financial institution server 300 may inform the result to the mobile terminal 60 through the relay system 100.

The QR code may be attached or printed onto a product advertised on an offline medium. The QR code may include a seller (or seller's corporate registration number), a store (e.g., Internet URL), a price and validity information.

The validity information includes information on a valid sale period on a product advertised on an offline medium. If a time point when an offline medium has been issued is greatly different from a time point when a purchaser has seen an advertisement on a product, the product may not be valid. For instance, if a purchaser requests to purchase a product on the sale in a mart or a department store after a sale period, the product may not be valid.

An application (App), through which the mobile terminal 60 captures a QR code and then provides the QR code to the relay system 100, may be installed at the mobile terminal 60. In case of) a product transaction using a QR code, the App may further include a function to capture a QR code and transmitting a barcode value obtained from a captured image or the captured QR code, to the relay system 100.

The relay system 100 recognizes the QR code provided from the mobile terminal 60, thereby specifying a product desired by the mobile terminal 60 and verifying a seller and a store of the product. And the relay system 100 determines whether the sale of the product is valid or not based on validity information. Generally, a price of a product advertised through an offline medium may become different as time lapses. In this case, the product may be a product for a temporary sale or a product for a bargain sale.

In a case where a product of which purchase is desired by the mobile terminal 60 is valid, the relay system 100 may request to deliver the product from the mobile terminal 50 of a seller. Alternatively, the relay system 100 may request to deliver the product from a personal computer (not shown) of the seller or a server (not shown).

An authentication method of the mobile terminal 60 may be performed using an authentication number by the financial institution server 300, or an OTP. The authentication method of the mobile terminal 60 using an OTP has been aforementioned with reference to FIG. 1, and thus detailed explanations thereof will be omitted.

In this embodiment, a user of the mobile terminal 60 does not utilize financial payment-related information, and a complete type of an OID is provided only at the financial institution server 300. This has been aforementioned with reference to FIG. 1, and thus explanations thereof will be omitted.

The relay system may relay a product transaction using a product mapping code exposed to an online or offline, rather than using a QR code. For instance, the mobile terminal 60 of FIG. 2 may purchase a product using a product mapping code displayed on a screen thereof in a mobile web environment. Alternatively, the mobile terminal 60 of FIG. 2 may capture a product code positioned in an offline environment, provide the product code to the relay system 100, and request the relay system 100 to pay.

The product mapping code may be configured as a seller code and a product code, which may be in the form of number strings, numbers+character strings, or character strings.

The product mapping code may be displayed on a web page, or may be printed on an offline medium such as an advertising flyer (leaflet). In case of using a product mapping code, the mobile terminal 60 may capture the product mapping code and then transmit the captured product mapping code to the relay system 100 in order to request payment. In a case where the product mapping code is displayed on an online web page, the product mapping code may be displayed on a general advertisement or may be included in a banner advertisement. For instance, in a case where the production mapping code is included in a banner advertisement, if the banner advertisement displayed on the mobile terminal 60 is touched, the banner advertisement transmits the product mapping code to a URL of the relay system 100. Then, the relay system 100 identifies a seller code and a product code from each other with reference to the product mapping code, and then relays a product transaction.

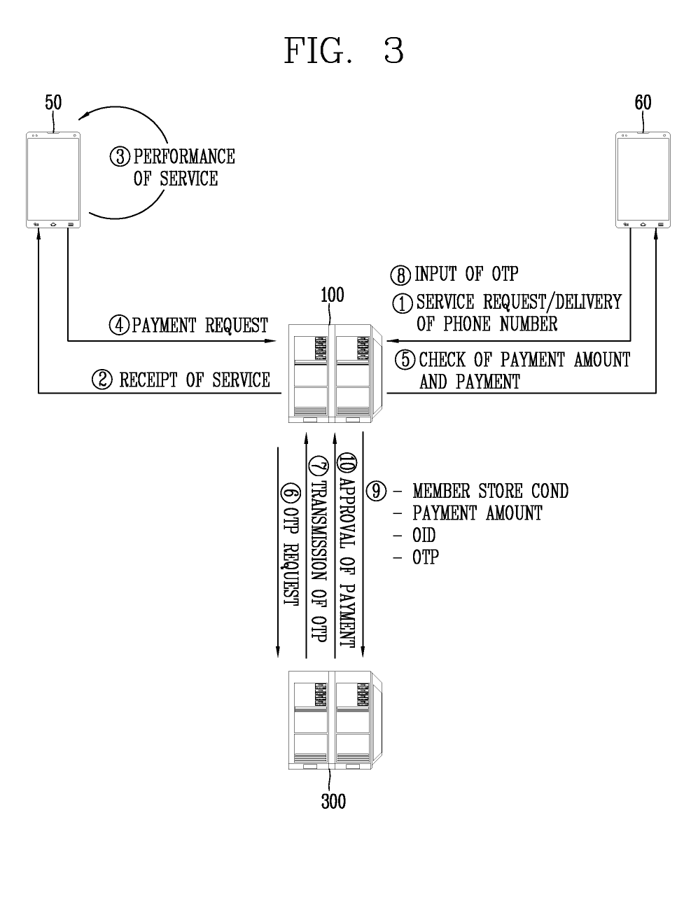

FIG. 3 is a conceptual view of a financial transaction relay system using a mobile terminal according to another embodiment of the present invention.

The relay system of FIG. 3 illustrates an example to relay a service transaction. Referring to FIG. 3, the mobile terminal 60 may denote a service applicant, and the mobile terminal 50 may denote a service provider. In this embodiment, it is assumed that the service applicant requests a designated driving service, and the service provider provides a designated driving service.

The service applicant may request a designated driving service from the relay system 100, using the mobile terminal 60. The service provider may register himself or herself as a designated driver applicant, using the mobile terminal 50. In this case, the service applicant and the service provider may register service conditions in the relay system 100. For instance, the service applicant and the service provider may register desired service costs or service locations. The relay system 100 may check positions of the mobile terminals 50 and 60 using the communication company server 250 which provides communication service to the mobile terminals 50 and 60. Alternatively, the relay system 100 may check positions of the mobile terminals 50 and 60 by receiving GPS position information from the mobile terminals 50 and 60. Under such configuration, the relay system 100 may select a service applicant and a service provider having a shortest distance therebetween, among service applicants and service providers. Alternatively, the relay system 100 may select a service provider which matches a service location desired by a service applicant. Upon matching between a service applicant and a service provider, the relay system 100 informs the matching result to the mobile terminal 50 of the service provider and the mobile terminal 60 of the service applicant. Then, the relay system 100 requests an authentication number from the financial institution server 300, so that the mobile terminal 50 or 60 can perform payment. Then, the relay system 100 receives the requested authentication number, and provides it to the mobile terminal 60 through the communication company server 250. If the mobile terminal 60 feeds back a right authentication number to the relay system 100, the relay system 100 transmits the authentication number to the financial institution server 300. In a case where the financial institution server 300 performs payment procedures, if the mobile terminals 50 and 60 request approval information, a payment history by the financial institution server 300 is provided to the mobile terminals 50 and 60.

For authentication of the mobile terminal 60, the financial institution server 300 may generate an OTP to provide it to the relay system 100, and the relay system 100 may transmit the received OTP to the mobile terminal 60. The relay system 100 may provide an OTP received from the mobile terminal 60, to the financial institution server 300. However, the present invention is not limited to this.

The relay system 100 may provide member store information to the financial institution server 300 instead of the mobile terminal 50. If the mobile terminal 50 has not been registered in a member store for card payment, member store information allocated to the mobile terminal 50 may be provided to the financial institution server 300.

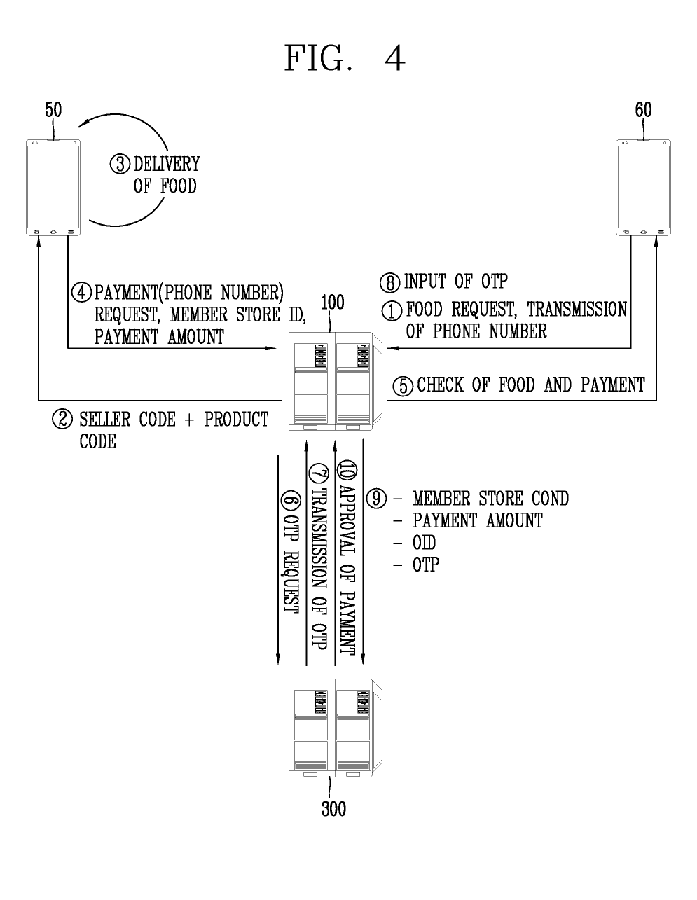

FIG. 4 is a conceptual view of a financial transaction relay system using a mobile terminal according to another embodiment of the present invention.

FIG. 4 illustrates an example that a restaurant business pays to the mobile terminal 60. Referring to FIG. 4, a user of the mobile terminal 60 provides the relay system 100 with a desired menu and a phone number of the mobile terminal 60. The relay system 100 informs the mobile terminal 50 of the desired menu and phone number, so as to order the menu. The mobile terminal 60 may inform a delivery place of the ordered menu. The mobile terminal 50 may cook the ordered menu, deliver the cooked menu to the delivery place, and may request the relay system 100 to pay. In this case, the mobile terminal 50 should provide information on a member store and information on payment amount, to the relay system 100.

The relay system 100 asks the mobile terminal 60 of whether the ordered menu has been delivered. If the ordered menu has been correctly delivered, the relay system 100 requests an OTP from the financial institution server 300. The relay system 100 receives the requested OTP, and transmits it to the mobile terminal 60. The mobile terminal 60 re-feeds back the received OTP to the relay system 100. The relay system 100 transmits the received OTP to the financial institution server 300. If the OTP is a correct one, the financial institution server 300 may request a region of an OID from the relay system 100. Then, the financial institution server 300 may determine a payment means of a user of the mobile terminal 60, based on the received OID. Then, the financial institution server 300 may approve payment for delivery of the menu.

The relay system 100 may transmit an SMS type of authentication number to the mobile terminal 60, and may authenticate the mobile terminal 50 through a feedback.

FIG. 4 illustrates an example that a restaurant business delivers food according to a menu and payment is performed. However, the relay system 100 may be used to pay for an intangible product, e.g., tutoring sessions on languages, art and physical educations and learning, a product AS, a moving company service, and other various types of services. This embodiment is not limited to the aforementioned product or service.

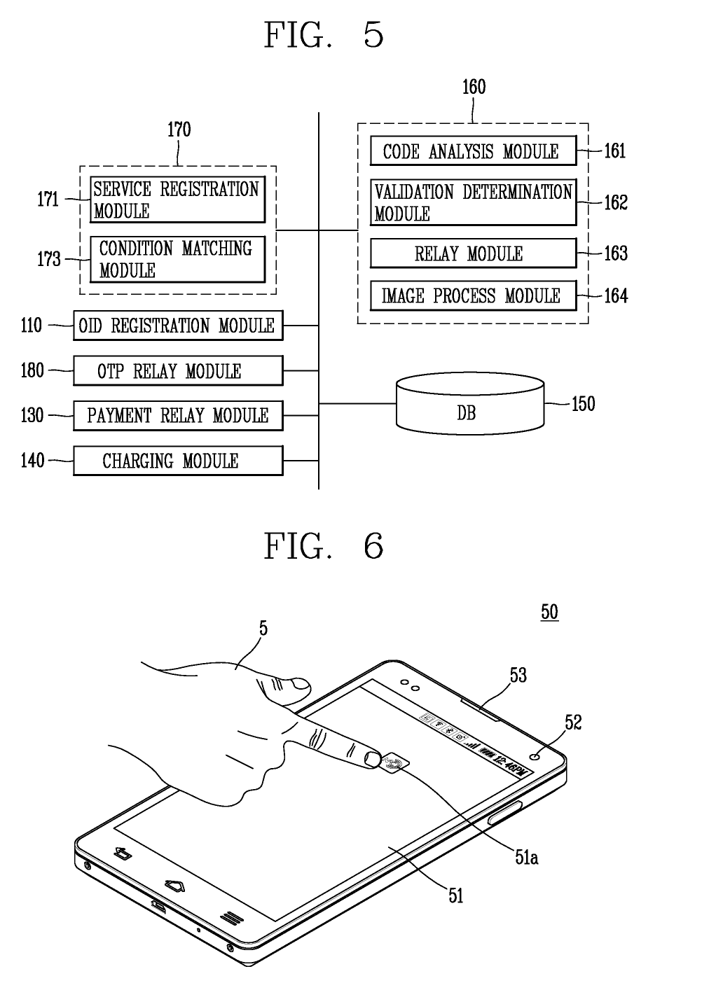

FIG. 5 is a block diagram of a financial transaction relay system using a mobile terminal according to an embodiment of the present invention.

Referring to FIG. 5, the relay system 100 may include an Online ID (OID) registration module 110, a payment relay module 130, a charging module 140, a database 150, a product transaction relay module 160, a service relay module 170, a One Time Password (OTP) relay module 180 and an OTP generation module 190.

The OID registration module 110 registers OID (Online ID) information on users of the mobile terminals 50 and 60 which are to perform a financial transaction using the mobile terminals 50 and 60, after receiving the OID information through the financial institution server 300. A complete OID may be registered only in the financial institution server 300, and part or the half of a code of the entire OID may be registered in the OID registration module 110. The users of the mobile terminals 50 and 60 may be connected to a personal computer (or notebook) or a network-connectable portable terminal through a network, thereby providing, to the relay system 100, at least one of names of the users of the mobile terminals 50 and 60, resident registration numbers, corporate registration numbers, phone numbers, addresses, account numbers, card numbers, passwords or authentication numbers on account numbers or card numbers, and personal information of the users. The complete OID is positioned at the financial institution server 300, and the relay system 100 is provided with part of the OID.

The relay system 100 is provided with only part of the OID which maps information with respect to a paying means, and requests the financial institution server 300 to pay. Under such configuration, the complete OID is not exposed to outside on a payment route connected to the mobile terminal 60, the relay system 100 and the financial institution server 300. The OID does not include information on a type of a credit card or an account number of the user of the mobile terminal 60. However, the financial institution server 300 is provided with information to be mapped with the OID. That is, the relay system 100 stably relays a mobile payment using the mobile terminal 60, while restricting spread of information of which security should be kept. At the same time, the relay system 100 provides information on a payment means and a desired payment amount of the user of the mobile terminal 60 to the financial institution server 300, so that the financial institution server 300 can pay.

As the relay system 100 relays payment of the mobile terminals 50 and 60, the financial institution server 300 can perform payment procedures. Accordingly, the existing system needs not be changed greatly, and excessive traffics occurring when the financial institution server 300 performs data communication with the mobile terminals 50 and 60 can be prevented.

When the mobile terminal 60 notifies a payment request, the payment relay module 130 may transmit a payment amount provided from the mobile terminal 60 to the financial institution server 300, and may request an OTP from the financial institution server 300.

For instance, the payment relay module 130 may request an OTP from a plurality of financial institution servers 300, and may transmit an SMS type of authentication number to the mobile terminal 50 using the communication company server 250. Then, the payment relay module 130 may be fed-back with the information from the mobile terminal 50, and then provide the information to the financial institution server 300.

The payment relay module 130 may relay so that the mobile terminals 50 and 60 using different card companies or banks can pay without limitations on a type of a card company or a bank of another party. That is, the users of the mobile terminals 50 and 60 need not know a type of a card company, a bank, an account number or a card number of another party who is to pay. The payment relay module 130 provides a region of an OID to the financial institution server 300. Through said a region of the OID, the payment relay module 130 cannot know account information or card information.

As aforementioned with reference to FIGS. 1 to 4, the payment relay module 130 may be valid in case of a product transaction or a service transaction between the two mobile terminals 50 and 60.

In case of a product transaction or a service transaction between the two mobile terminals 50 and 60, if the mobile terminal 60 which requests a product or a service and performs payment requests payment, the financial institution server 300 may be requested to pay using a region of an OID allocated to the mobile terminal 60. An OTP may be provided to the mobile terminal 60 to thus be fed back for payment.

The payment relay module 130 may provide a member store code to the financial institution server 300, instead of the mobile terminals 50 and 60. The payment relay module 130 may be provided with a member store code like a single member store. If one of the mobile terminals 50 and 60, a side which notifies a payment approval (i.e., a cost receiving side) is not provided with a member store code, the payment relay module 130 may provide a member store code to the financial institution server 300 instead of the mobile terminal 50 or 60. This is for a case where a small store or an individual is not registered in a card member store. If the financial institution server 300 is requested to pay, the financial institution server 300 may perform card payment instead of the mobile terminal 50 or 60.

The charging module 140 may be configured to charge a service fee due to payment by the payment relay module 130, or may charge a fee due to a product relay or a service relay.

In a case where a product transaction or a service transaction occurs from the product transaction relay module 160 or the service relay module 170, the charging module 140 may charge a product providing side, a service providing side or a product or service requesting side. In this case, the charging may be implemented in the form of a relay fee with respect to the relay system 100.

In a case where a user of the mobile terminal 50 captures a QR code printed or attached onto an offline medium and transmits the captured QR code to the product transaction relay module 160 for product purchase, the product transaction relay module 160 determines a seller, a store and a transaction validation by analyzing the QR code. If the transaction is valid, the product transaction relay module 160 performs a product order and a product delivery to the seller included in the QR code. Preferably, the product transaction relay module 160 may include a code analysis module 161, a validation determination module 162, a relay module 163 and an image process module 164.

The code analysis module 161 is configured to analyze a QR code provided from the mobile terminal 50, to thus analyze a store such as a seller, a web site of a product, an e-mail and an address of an offline store, and validation on a product transaction. The seller may be a unique number provided to a seller, or a seller's corporate registration number.

The validation determination module 162 determines whether a purchaser' desired product is valid or not, based on a sale validity date written on the QR code.

If a purchaser' desired product is not valid, the validation determination module 162 may determine a transaction to be invalid, and may inform the mobile terminal 50 of the determination result.

In a case where a QR code transmitted from the mobile terminal 50 is an image type, the image process module 164 processes the image to thus read information included in the QR code. In the present invention, the mobile terminal 50 may capture a QR code, and then may provide information included in the QR code to the product transaction relay module 160. Alternatively, the mobile terminal 50 may provide an image itself of the QR code. In a case where the mobile terminal 50 provides an image of the QR code, the image process module 164 may be operated.

The relay module 163 may request a product order and a product delivery to a store of a product which has been determined to be valid for sale. If the mobile terminal 60 informs a product reception, the relay module 163 may request payment of the product from the financial institution server 300. Then, the relay module 163 may inform the mobile terminals 50 and 60 of the request result.

The service relay module 170 may register intangible service providers and intangible service requesters, and may enable a service transaction by matching a service provider and a service requester with each other, each person who satisfies service conditions.

The service relay module 170 may include a service registration module 171 and a condition matching module 173. The service registration module 171 may register a parcel which is not directly purchased, a designated driving, various types of services, a service provider's position and costs.

The condition matching module 173 may match a service provider and a service requester with each other, based on a service cost registered in the service registration module 171, and a service suppliable range. After informing the service provider and the service requester of a phone number of another party, the condition matching module 173 may allow one of the service provider and the service requester to perform payment.

For instance, the service registration module 171 may register the designated driving requesters and the designated driver applicants aforementioned with reference to FIG. 3, and may register desired costs and desired service positions by the designated driving requesters and the designated driver applicants. The condition matching module 173 may search for conditions which can match with each other, among conditions presented by the designated driving requesters and the designated driver applicants registered in the service registration module 171. Then, the condition matching module 173 may inform the selected designated driving requester and the designated driver applicant of a phone number of another party. And the condition matching module 173 may allow a mobile terminal of one of the designated driving requester and the designated driver applicant, to perform payment. If the designated driving requester is to pay, the condition matching module 173 may request the financial institution server 300 to pay, based on payment reference information registered in the OID registration module 110 by the designated driving requester, or payment reference information transmitted from a mobile terminal of the designated driving requester. The payment relay module 130 may perform payment, and may inform the designated driving requester of the result.

The service relay module 170 is configured to allow the mobile terminals 50 and 60 to arrange service conditions and to perform payment procedures therebetween.

The OTP relay module 180 is configured to relay an OTP acquired from the financial institution server 300 to the mobile terminal, in the occurrence of payment request between the mobile terminals 50 and 60. The OTP may be implemented as numbers. Alternatively, the OTP may be implemented in the form of combination of numbers and characters, or combination of numbers, characters and special characters. The OTP is used to determine whether the mobile terminals 50 and 60 have a right payment route. If the mobile terminal 50 feeds back a correct OTP to thus be authenticated, the OTP may be automatically deleted. The OTP may be used as payment information provided to the financial institution server 300 from the relay system 100, as well as authentication information. In this case, the OTP may be used as payment reference information without being deleted. When the OTP is used as payment reference information, the relay system 100 may request payment by providing, to the financial institution server 300, a phone number of the mobile terminal 50 and the OTP (or an authentication result through the OTP).

The OTP relay module 180 acquires payment costs and member store information from the mobile terminal 60, and requests the financial institution server 300 to issue an OTP when requesting for payment using the acquired payment costs and member store information. The OTP relay module 180 provides the OTP acquired from the financial institution server 300 to the mobile terminal 60, and provides the OTP fed back from the mobile terminal 60 to the financial institution server 300 for authentication of the mobile terminal 60. The mobile terminal 60 may receive its address information provided to the mobile terminal 50, from the mobile terminal 50. Then, the mobile terminal 60 may provide its address information to the OTP relay module 180 together with payment costs and member store information.

The OTP generation module 190 is provided so that the relay system 100 can authenticate the mobile terminal 60 without the financial institution server 300. Once the mobile terminal 60 checks payment costs and member store information provided from the relay system 100 and requests payment, the OTP generation module 190 may generate an OTP which is abandoned after authentication. And the OTP generation module 190 may provide the OTP to the mobile terminal 60, and may authenticate the mobile terminal 60 through a response. In a case where the mobile terminal 60 is authenticated by the OTP generation module 190, the OTP relay module 180 is not required, and the financial institution server 300 needs not perform an OTP authentication. However, the financial institution server 300 may additionally authenticate the mobile terminal 60, using an SMS type of authentication number.

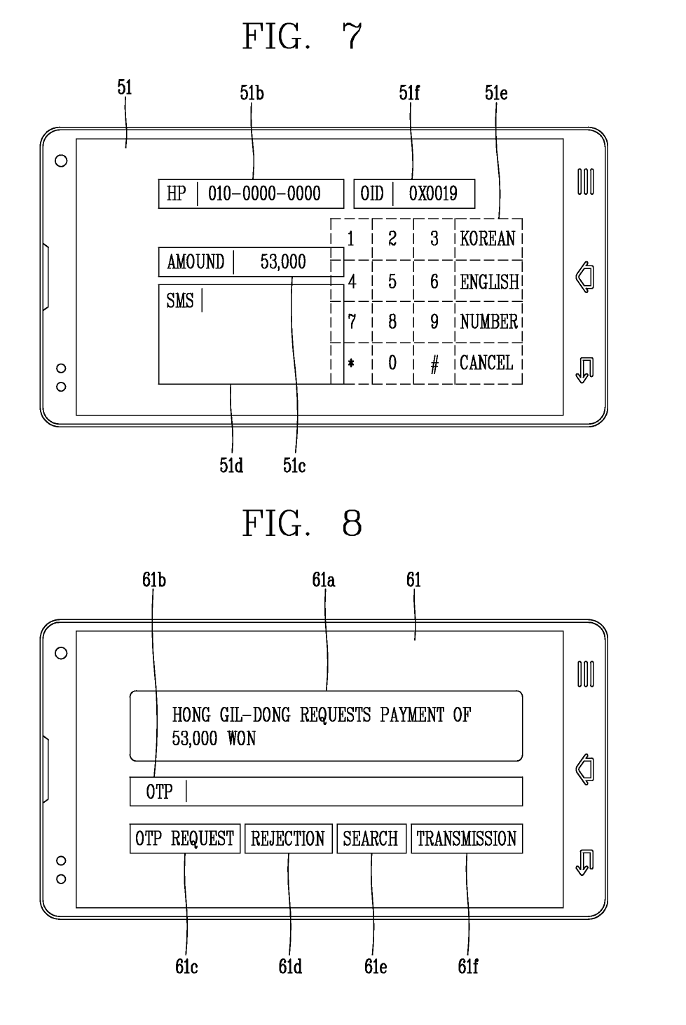

FIGS. 6 to 8 are views for explaining payment procedures using a mobile terminal.

Referring to FIG. 6, a user who wishes to pay may touch an icon 51a of an application (App), which is displayed on a touch screen 51, using his or her finger 5. As shown in FIG. 6, a mobile terminal 50 may display an interface on the touch screen 51 in response to a user's touch input.

Referring to FIG. 7, the touch screen 51 may display a cost input menu 51c for inputting costs to be input, a phone number input menu 51b for inputting a number of a mobile terminal which is to pay, a text input menu 51d for cost input, an OID input menu 51f, and a virtual keyboard 51e.

A user may input the amount of costs to be input to the cost input menu 51c, and may input texts, numbers and special characters to the text input menu 51d and the OID input menu 51f, using the virtual keyboard 51e. The virtual keyboard 51e, which is provided at a smart phone or a portable phone, is displayed in an overlapped manner with menus displayed on the touch screen 51. The virtual keyboard 51e may be processed to be semi-transparent so that a user can view content displayed on the phone number input menu 51b, the cost input menu 51c, and the text input menu 51d when using the virtual keyboard 51e. Further, the touch screen 51 includes a menu for inputting the Korean alphabet, the English alphabet, numbers, etc. through the text input menu 51d.

Once the content displayed on the phone number input menu 51b, the cost input menu 51c, and the text input menu 51d of FIG. 7 is transmitted to the mobile terminal 60 for receiving payment, the following menus may be displayed on a touch screen 61 of the mobile terminal 60 as shown in FIG. 8. Referring to FIG. 8, the touch screen 61a may include a guidance message 61a indicating that a user who has paid (e.g., Hong Gil-dong) requests cost input of 53,000 won, an OTP input menu 61b for inputting an OTP transmitted from the relay system 100, an OTP request menu 61c for requesting for an OTP, a rejection menu 61d for rejecting payment requested by the user (Hong Gil-dong), a search menu 61e for searching for content received from the user (Hong Gil-dong) in the form of an SMS, and a transmission menu 61e for transmitting an OTP written on the OTP input menu 61b to the mobile terminal 50 which has requested cost input.

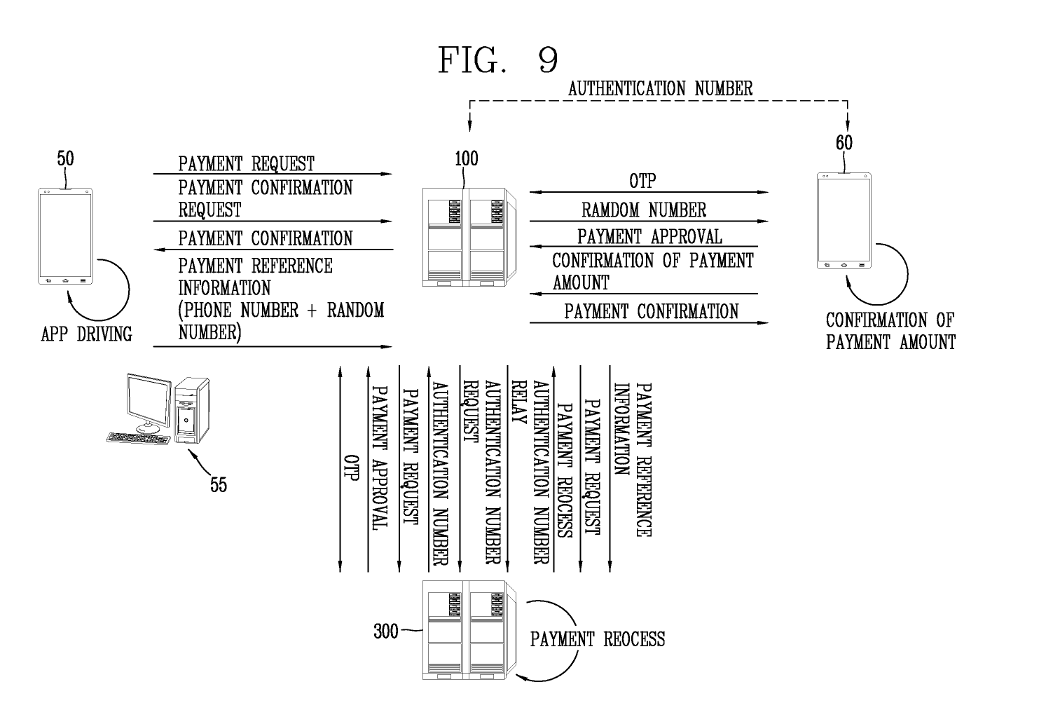

FIG. 9 is a conceptual view of a financial transaction relay system using a mobile terminal according to another embodiment of the present invention.

Referring to FIG. 9, the financial transaction relay system using a mobile terminal according to this embodiment is the same as the relay system of FIG. 1, except that a phone number of the mobile terminal 60 and an OTP are used as payment reference information. Accordingly, the same explanations as those of FIG. 1 will be omitted, and the omitted explanations are understood with reference to FIG. 1.

Referring to FIG. 9, the relay system 100 generates an One Time Password (OTP) upon request payment from the mobile terminal 50, and transmits the generated OTP to the mobile terminal 60. The mobile terminal 60 may receive, from the relay system 100, an OTP and a phone number of the mobile terminal 50 which has requested payment. Then, the mobile terminal 60 may transmit the OTP to the phone number of the mobile terminal 50. The relay system 100 may provide the OTP to the financial institution server 300, and the financial institution server 300 may use the OTP when authenticating the mobile terminal 60 for later process of payment with respect to the mobile terminal 60.

The mobile terminal 50 provides the OTP received from the mobile terminal 60, to the relay system 100 as payment reference information. The relay system 100 submits the phone number and the OTP of the mobile terminal 60 to the financial institution server 300 for request payment. The financial institution server 300 may compare the OTP received from the relay system 100, with the OTP submitted to the relay system 100 as payment basic information, thereby authenticating the mobile terminal 50 and then performing payment. That is, upon input of the OTP by the mobile terminal 60, payment requested by the mobile terminal 50 is performed. In this case, an additional identification means for specifying the mobile terminal 60 is not required. One of the relay system 100 and the financial institution server 300 may include card information corresponding to the phone number of the mobile terminal 60, e.g., a card number, an expiration date, a card validation code (CVC) and other information required for card usage. The financial institution server 300 may be a card server for dealing with a credit card.

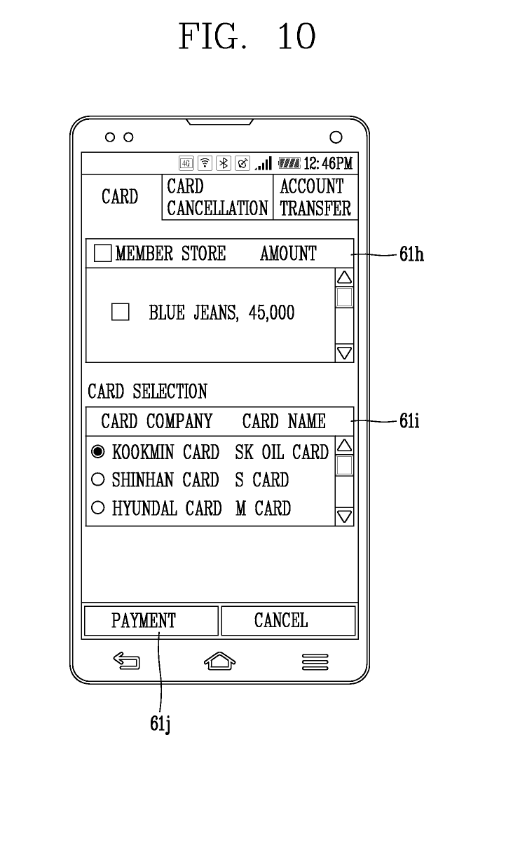

FIG. 10 is a view for explaining payment request procedures using a mobile terminal.

Referring to FIG. 10, an application installed at the mobile terminal 60 allows a payment means and member store information acquired from the mobile terminal 50 to be displayed. Further, the application allows a user of the mobile terminal 60 to select a desired payment means and to request payment from the relay system 100.

FIG. 10 illustrates an example to display a member store information display menu 61h for displaying information on a member store to which payment is performed, a card selection menu 61i in a case where a payment means is a card, and a payment request menu 61j. A list of card companies (e.g., Kookmin card, Shinhan card and Hyundai card), which can be used as a payment means by the user of the mobile terminal 60, is displayed on a screen of the mobile terminal 60. And a card selected from the user of the mobile terminal 60 may be used for payment. That is, the mobile terminal 60 may acquire member store information through the relay system 100, then determine whether a payment object is correct, and then may select a payment means (e.g., Kookmin card, SK oil card).

1. A financial transaction relay system using a mobile terminal, comprising:
an online ID (OID) registration module configured to acquire financial information including card information or account information, from a user of a first mobile terminal which purchases a product and a service, and a user of a second mobile terminal which provides the product and the service, and configured to acquire a region of an online ID corresponding to the card information or the account information, from a financial institution server corresponding to the acquired card information or account information;
a payment relay module configured to receive a phone number of a first mobile terminal which purchases a good and a service, configured to acquire the phone number of the first mobile terminal, a payment cost and member store information on a second mobile terminal, from the second mobile terminal which provides the product and the service, configured to provide the acquired payment cost and member store information and card information or account information to the first mobile terminal, and configured to request the first mobile terminal to perform payment by providing a payment cost and member store information to a financial institution server corresponding to a card or an account selected from the first mobile terminal for payment;
an OID relay module configured to provide mapping information on a payment means of the first mobile terminal, by providing one region of an OLD with respect to the card or the account selected by the first mobile terminal, to the financial institution server; and
an OTP relay module configured to acquire an OTP for the payment from the financial institution server, to provide the OTP to the first mobile terminal, to receive a response from the first mobile terminal, to provide the response to the financial institution server, and thus to authenticate the first mobile terminal,
wherein the financial institution server determines the payment means based on an entire OLD with respect to said one region.

2. The financial transaction relay system using a mobile terminal of claim 1, wherein the financial institution server is provided with an entire code with respect to a region of an OID provided from the OLD relay module, and
wherein the entire code is information mapped with the card information, the account information and the entire OID.

3. The financial transaction relay system using a mobile terminal of claim 1, wherein the OTP is deleted after authentication of the first mobile terminal is completed.

4. The financial transaction relay system using a mobile terminal of claim 1, wherein in a case where the user of the second mobile terminal which provides the product and the service is not registered in a card member store, the payment relay module performs payment by providing a member store code of the financial transaction relay system using a mobile terminal, to the financial institution server.

5. The financial transaction relay system using a mobile terminal of claim 4, further comprising a product transaction relay module configured to request payment with respect to a second mobile terminal of a product seller corresponding to a product code, upon receipt of the product code printed and attached to an advertising paper, an advertising board and a newspaper, from the first mobile terminal.

6. The financial transaction relay system using a mobile terminal of claim 5, wherein the product code includes a product mapping code of a product displayed in a web environment of the first mobile terminal.

7. The financial transaction relay system using a mobile terminal of claim 5, wherein the product code further includes validity information on a sale validity date of a product advertised on the advertising paper, the advertising board and the newspaper offline.

8. The financial transaction relay system using a mobile terminal of claim 7, further comprising a validation determination module configured to determine whether a purchaser' desired product is valid or not, based on the sale validity date from the validity information, and configured to inform the first mobile terminal of guidance information on a valid transaction when the purchaser' desired product is not valid.

9. The financial transaction relay system using a mobile terminal of claim 8, wherein in a case where the validation determination module determines that a purchaser' desired product is valid, the product transaction relay module requests a product order and a product delivery from a store of the product, and
wherein upon notification of product reception from the first mobile terminal, the product transaction relay module requests the financial institution server to process payment for the product.

10. The financial transaction relay system using a mobile terminal of claim 5, wherein an application, which is configured to capture the product code and to transmit the captured product code to the product transaction relay module, is installed at one of the first mobile terminal and the second mobile terminal.

11. The financial transaction relay system using a mobile terminal of claim 9, further comprising:
a service registration module configured to register information on a user of the second mobile terminal, a service providing position, a service cost, a user of the first mobile terminal, a service request position, and a service request cost; and
a service matching module configured to match a service requester and a service provider with each other based on the information registered in the service registration module.
